(19) United States
(12) Patent Application Publication
(10) Pub. No.: US 2026/0225332 A1
(43) Pub. Date: Aug. 6, 2026

(54) COMPOSITE SPACER RING AND PRODUCTION METHOD THEREOF

(71) Applicant: SAFRAN, PARIS (FR)

(72) Inventors: Rémi Roland Robert MERCIER, MOISSY-CRAMAYEL (FR); Patrick DUNLEAVY, MOISSY-CRAMAYEL (FR); Julien Philippe GALLET, MOISSY-CRAMAYEL (FR)

(73) Assignee: SAFRAN, PARIS (FR)

(21) Appl. No.: 19/150,820

(22) PCT Filed: Jan. 25, 2024
(86) PCT No.: PCT/FR2024/050106

§ 371 Date: Jul. 24, 2025

(30) Foreign Application Priority Data
Jan. 25, 2023 (FR) FR2300687

(51) Int. Cl. B29C 70/70; B29C 70/38; B29L 31/26; F01D 11/00

(52) U.S. Cl. CPC B29C 70/70; B29C 70/382; F01D 11/001; B29C 2793/0081; B29L 2031/26; F05D 2300/603

(57) ABSTRACT

This method (200) for producing a composite spacer ring for a turbine engine fan comprises preparing (210) an upstream skin preform, preparing (220) a downstream skin preform, preparing (230) an insert preform, inserting (251) the insert preform between the upstream skin preform and the downstream skin preform so as to form a rotating spacer ring preform, and baking (260) the rotating spacer ring preform. The preparation (210) of the upstream skin preform and/or the preparation (220) of the downstream skin preform comprises drape forming (212, 222) prepreg tows on a skin mold by means of automated fiber placement.

### FIELD OF THE INVENTION

The present invention relates to spacer rings for turbine engine fans, and more particularly to their method of manufacture.

### TECHNICAL BACKGROUND

Turbine engine fan rotors most often comprise a fan disc having a plurality of blades fixed to the disc and extending in substantially radial directions from the disc. They also comprise inter-blade platforms interposed between the blades to internally delimit the secondary flow duct. These inter-blade platforms are secured to the disc by an upstream retaining flange and a downstream retaining flange.

One type of downstream retaining flange is a “rotating spacer ring” or “flow-path spacer”. These rotating spacer rings comprise a radial ferrule fixed to a part integral with the disc and extended by a ring projecting axially upstream. This ring is defined by revolution of a generally V-shaped generatrix pointing upstream. This ring comprises an inner leg defining an axial shoulder facing inwards, which abuts against the inter-blade platforms and an outer leg which defines a generally frustoconical outer surface internally bounding the secondary flow duct. The outer leg is extended by a hook-shaped appendage to provide a seal between the fan rotor and the turbine engine casing.

Conventionally, rotating spacer rings are made of metal, most often of titanium. Recently, it has been proposed that, in order to make them lighter, they should be made of composite material using the resin transfer moulding technique.

However, producing rotating spacer rings using resin transfer moulding is not entirely satisfactory. More specifically, this method is costly and complex to implement.

A technique for manufacturing composite preforms is also known, called “automatic fibre placement” (AFP), in which a drape forming machine lays a strip consisting of a plurality of juxtaposed narrow ribbons (generally 3 to 13 mm wide), called “tows”, on a support by means of a laying head. These tows consist of fibres oriented in the direction of elongation of the tow and embedded in a matrix. They are introduced into the head by a feed system containing a plurality of reels, each containing one of the tows to be placed. The tows are unwound from the reels and fed to the head, which heats them just before a roller presses them onto the support. The head is connected to a robot that positions it during drape forming, and the whole system is controlled by a computer program that has been defined according to the desired fibre alignment in the final product. Automatic fibre placement thus enables the production of composite material parts in a highly reproducible manner.

In the aeronautical industry, this technique is generally used to produce large, simple geometric components, such as wing and fuselage elements.

However, because of the constraints imposed by the dimensions of the rollers and the width of the tows, automatic fibre placement is generally considered unsuitable for the production of small parts or parts with complex geometries, such as rotating spacer rings, because such parts would require specific, non-immediate depositing and/or cutting strategies.

### DISCLOSURE OF THE INVENTION

One aim of the invention is to simplify and automate the manufacture of rotating spacer rings in such a way as to reduce their cost.

For this purpose, one object of the invention according to a first aspect is a method for manufacturing a spacer ring made of composite material for a turbine engine fan, said spacer ring comprising an upstream skin delimiting an upstream face of the spacer ring when it is mounted on the turbine engine, a downstream skin delimiting a downstream face of the spacer ring when it is mounted on the turbine engine, and an annular insert housed between the upstream and downstream skins, the manufacturing method comprising the following steps:
preparing an upstream skin preform,
preparing a downstream skin preform,
preparing an insert preform,
inserting the insert preform between the upstream skin preform and the downstream skin preform so as to form a rotating spacer ring preform, and
baking the rotating spacer ring preform,
wherein the preparation of the upstream skin preform and/or the preparation of the downstream skin preform comprises drape forming prepreg tows over a skin mould by automatic fibre placement.

According to particular embodiments of the invention, the manufacturing method also has one or more of the following features, taken alone or in any technically possible combination:
drape forming prepreg tows over the skin mould produces an annular preform blank, the preparation of the upstream skin preform and/or the preparation of the downstream skin preform comprising, following said drape forming, shaping of the preform blank so as to form the upstream skin preform and, respectively, the downstream skin preform;
shaping of the preform blank is performed by thermoforming;
the skin mould has a rotationally symmetric shape centred on an axis of revolution, a cylindrical reference frame being associated with the skin mould with, at each point, an axial direction parallel to the axis of revolution, a radial direction joining the axis of revolution to said point and a circumferential direction orthogonal to the axial and radial directions, each prepreg tow being drape formed in a direction forming, at each point, a non-zero angle with the local circumferential direction;
preparing the insert preform comprises drape forming prepreg tows over an insert mould by automatic fibre placement, the insert mould having a disc shape, the prepreg tows being drape formed over a rim of said disc;
the disc is rotationally symmetric about a central axis, a cylindrical reference frame is associated with the insert mould with, at each point, an axial direction parallel to the central axis, a radial direction joining the central axis to said point and a circumferential direction orthogonal to the axial and radial directions, and each prepreg tow is drape formed substantially parallel to the circumferential direction;
drape forming of prepreg tows over the insert mould comprises:
   producing at least one stack of layers of prepreg tows stacked in the radial direction, said stack having an axial edge defined by drape forming which has an axial extension, and
   machining a machined axial edge of the stack, opposite the axial edge defined by drape forming, by clean cutting of the stack;
for at least one stack, the axial edge defined by drape forming is curved, the machined axial edge being straight, or the axial edge defined by drape forming is inclined, the machined axial edge being radial.
a plurality of stacks are produced, said stacks comprising an inner stack and an outer stack radially superimposed on the inner stack, the machined axial edge of the inner stack being obtained by clean cutting of the inner stack along a primary cutting surface and the machined axial edge of the outer stack being obtained by clean cutting of the outer stack along a secondary cutting surface, different from the primary cutting surface;
the axial edge defined by drape forming of the outer stack radially extends the machined axial edge of the inner stack, the secondary cutting surface radially extending the axial edge defined by drape forming of the inner stack;
the axial edge defined by drape forming of the outer stack radially extends the axial edge defined by drape forming of the inner stack, the secondary cutting surface radially extending the machined axial edge of the inner stack;
the machined axial edge is obtained by clean cutting of the stack along a radial or frustoconical cutting surface; and
the spacer ring is a rotating spacer ring.

Another object of the invention, according to a second aspect, is a spacer ring obtained by means of such a method.

Yet another object of the invention, according to a third aspect, is a fan rotor comprising such a spacer ring.

According to a fourth aspect, another object of the invention is a turbine engine comprising such a fan rotor.

According to a fifth aspect, another object of the invention is an aircraft comprising such a turbine engine.

### BRIEF DESCRIPTION OF THE FIGURES

Other features and advantages of the invention will appear on reading the description which follows, provided only by way of example and with reference to the attached drawings, in which:

FIG. 1 is a top view of an aircraft according to an exemplary embodiment of the invention,

FIG. 2 is a simplified cross-sectional view of a turbine engine of the aircraft of FIG. 1,

FIG. 3 is a view of a detail marked III in FIG. 2,

FIG. 4 is a cross-sectional view of a rotating spacer ring of the turbine engine of FIG. 2,

FIG. 5 is a diagram illustrating a manufacturing method for the rotating spacer ring of FIG. 4,

FIG. 6 is a diagram illustrating a step in the preparation of an insert preform of the manufacturing method of FIG. 5, and

FIGS. 7 to 25 illustrate various steps and sub-steps of the manufacturing method of FIG. 5.

### DETAILED DESCRIPTION OF AN EXEMPLARY EMBODIMENT

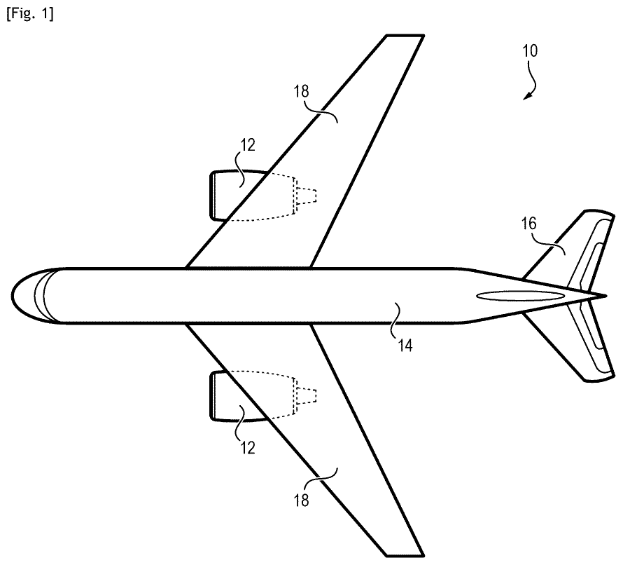

The aircraft 10 shown in FIG. 1 comprises turbine engines 12 to propel it.

In the example shown, the aircraft 10 is an aeroplane. Said aeroplane comprises, in conventional manner, a fuselage 14, a tail assembly 16 and two wings 18. In this case, there are two turbine engines 12 each mounted under a respective wing 18. In an alternative (not shown), the turbine engines 12 are disposed along the fuselage 14, for example close to the tail assembly 16. In another alternative (also not shown), the aircraft 10 comprises a single turbine engine 12 or at least three turbine engines 12.

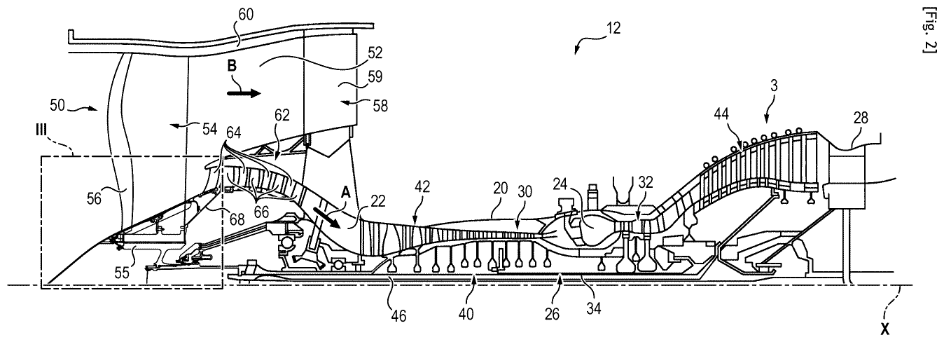

One of the turbine engines 12 is shown in FIG. 2.

As can be seen in this figure, the turbine engine 12 is elongate along a longitudinal axis X. Typically, it has an angular symmetry about said longitudinal axis X, in other words there is at least one angle for which the turbine engine is invariant under rotation about the longitudinal axis X.

Here and hereinafter, the terms “inside” and “outside”, “inner” and “outer”, as well as their variations, are understood to refer to the axis X, an element qualified as “inside” or “inner” being oriented towards the axis X, while an “outside” or “outer” element is oriented in the direction opposite to the axis X. The terms “radial” and its variations are understood to refer to a direction orthogonal to the axis X.

Conventionally, the turbine engine 12 comprises a nacelle 20, an inner duct 22 for the circulation of an air flow through the nacelle 20, a combustion chamber 24 housed in the duct 22, an engine spool 26 and an exhaust gas nozzle 28.

Hereinafter, the terms “upstream” and “downstream” are understood to refer to a flow direction of the air flow through the duct 22.

The engine spool 26 comprises a compressor 30, a turbine 32 and a drive shaft 34 coupling the turbine 32 to the compressor 30 for driving of the compressor 30 by the turbine 32. The compressor 30 is disposed upstream of the combustion chamber 24 and feeds the combustion chamber 24 with compressed air. The turbine 32 is disposed downstream of the combustion chamber 24 and receives the exhaust gas leaving the combustion chamber 24.

The longitudinal axis X is the axis of rotation of the drive shaft 34.

The drive shaft 34 is guided in rotation with respect to the nacelle 20 by means of bearings (not shown).

In the example shown, the turbine engine 12 is a multi-spool turbine engine, in particular a two-spool turbine engine, comprising a low-pressure spool 40 in addition to the engine spool 26. The engine spool 26 therefore constitutes a high-pressure spool, the compressor 30 being a high-pressure compressor, the turbine 32 being a high-pressure turbine and the drive shaft 34 being a high-pressure shaft.

The low-pressure spool 40 comprises a low-pressure compressor 42, a low-pressure turbine 44 and a low-pressure shaft 46 coupling the low-pressure turbine 44 to the low-pressure compressor 42, for driving of the low-pressure compressor 42 by the low-pressure turbine 44.

The low-pressure compressor 42 is disposed upstream of the high-pressure compressor 30 and feeds the latter with compressed air. The low-pressure turbine 44 is disposed downstream of the high-pressure turbine 32 and receives the exhaust gas leaving the latter.

The low-pressure shaft 46 is guided in rotation with respect to the nacelle 20 by means of bearings (not shown).

The low-pressure shaft 46 is coaxial with the high-pressure shaft 34. Its axis of rotation is therefore also the longitudinal axis X. In particular, the low-pressure shaft 46 extends inside the high-pressure shaft 34.

The turbine engine 12 also comprises a fan 50 for driving the air flow in an outer circulation duct 52 surrounding the nacelle 20. Thus a primary air flow A (hot), constituted by the portion of the air flow driven in the inner circulation duct 22, can be distinguish from a secondary air flow B (cold), constituted by the portion of the air flow driven in the outer circulation duct 52.

The fan 50 comprises a fan rotor 54. This fan rotor 54 is rotatably mounted relative to the nacelle 20 about the longitudinal axis X. It comprises a disc 55 provided with fan blades 56 extending substantially radially outwards from the disc 55. These blades 56, when they are rotated, drive the air flow in the outer circulation duct 52.

The fan rotor 54 is rotated by the low-pressure turbine 44, via the low-pressure shaft 46. In the example shown, this driving is direct, in other words the fan rotor 54 is constrained to rotate with the low-pressure shaft 46. In an alternative (not shown), this driving is achieved by means of a reducer 57, enabling the fan rotor 54 to rotate at a speed less than that of the low-pressure shaft 46.

The fan rotor 54 is, in particular, disposed upstream of the inner circulation duct 22 and likewise drives the air flow in the latter.

In the example shown, the fan 50 also comprises a fan stator 58, also called a flow straightener, comprising stationary vanes 59 arranged at the periphery of the nacelle 20, in the outer circulation duct 52, along a plane orthogonal to the longitudinal axis X. This fan stator 58 is here arranged downstream of the fan rotor 54.

The outer circulation duct 52 is defined here between the nacelle 20 and a fan casing 60 surrounding the fan 50. The turbine engine 12 typically consists of a turbojet with high bypass ratio, the bypass ratio being defined as the ratio of the flow rate of the secondary flow B (cold) divided by the flow rate of the primary flow A (hot).

In the example shown, the turbine engine 12 also comprises a booster compressor 62 at the inlet to the inner duct 22. This booster compressor 62 comprises alternating fixed vanes 64 and moving blades 66 extending successively into the inner duct 22. The fixed vanes 64 are integral with the nacelle 20. The moving blades 66 are mounted on a booster-compressor shaft 68. This booster-compressor shaft 68 is fixed to the disc 55 of the fan rotor 54.

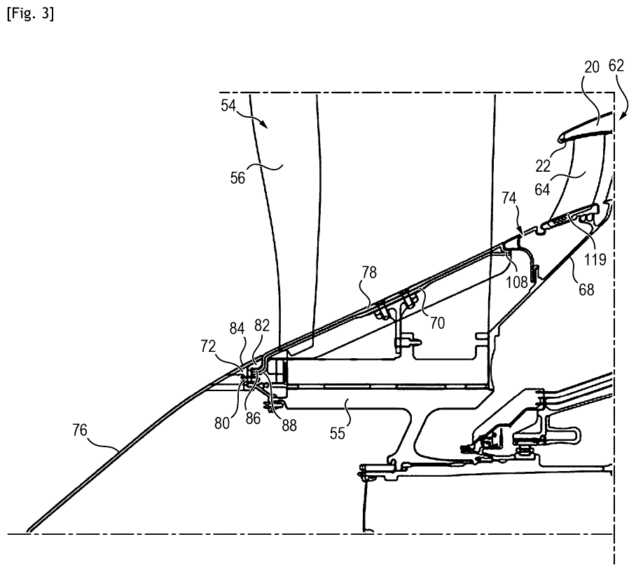

With reference to FIG. 3, the fan rotor 54 also comprises inter-blade platforms 70 interposed circumferentially between the blades 56 and flanges 72, 74 retaining said platforms 70 to the disc 55. In the example shown, the fan rotor 54 also comprises a conical flywheel 76 mounted upstream of the disc 55 and the inter-blade platforms 70.

Each inter-blade platform 70 has an outer surface 78 which internally delimits part of the outer duct 52 between the blades 56.

The flanges 72, 74 are each annular in shape and centred on the longitudinal axis X. As with the inter-blade platforms 70, they each define part of the outer duct 52 at the fan 50. They comprise an upstream flange 72, located upstream of the inter-blade platforms 70, and a downstream flange 74 located downstream of the inter-blade platforms 70.

Here, the upstream flange 72 is interposed between the flywheel 76 and the inter-blade platforms 70. It comprises a radial ferrule 80 fixed to the disc 55 and a lug 82 projecting axially downstream from said ferrule 80. This lug 82 has an outer surface 84 internally delimiting part of the outer duct 52 at the fan 50 and an inner surface 86 abutting against an upstream end 88 of the inter-blade platforms 70.

The downstream flange 74 is formed by a rotating spacer ring 90. Typically, it has an outer diameter of between 600 and 1200 mm.

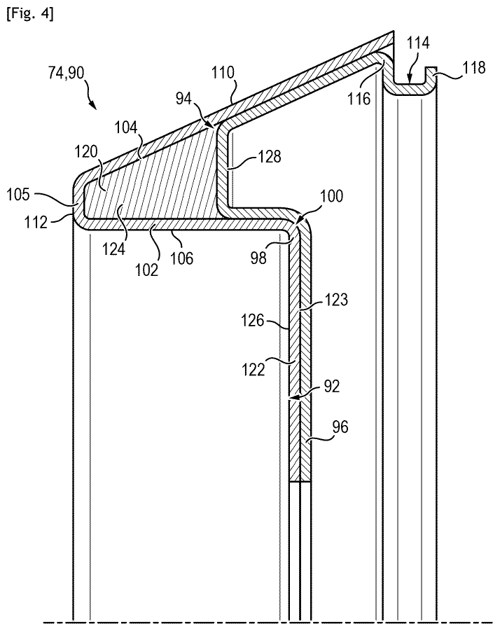

With reference to FIG. 4, the rotating spacer ring 90 comprises a radial ferrule 92 fixed to the booster compressor shaft 68 and a ring 94 extending the ferrule 92 radially outwards.

The ferrule 92 is substantially planar. It extends substantially in a radial plane. It has an inner end 96 for attachment to the booster-compressor shaft 68 and an outer end 98 for connection to the ring 94.

The ring 94 extends around the ferrule 92 and projects axially upstream relative to said ferrule 92. It is connected to the ferrule 92 by a fillet 100, the concavity of which faces upstream. The fillet 100 typically has a radius of curvature of between 10 and 60 mm.

The ring 94 is defined by revolution about the axis X of a generally V-shaped generatrix pointing upstream. It comprises an inner leg 102 and an outer leg 104 converging towards each other in an upstream direction to an upstream end 105 of the ring 94.

The inner leg 102 defines an axial shoulder 106 facing inwards. This shoulder 106 is substantially cylindrical, i.e. it has no radial extension or at least a very small radial extension compared with its other dimensions. In particular, it is substantially circularly cylindrical. The shoulder 106 abuts against a downstream end 108 (FIG. 2) of the inter-blade platforms 70.

In particular, the inner leg 102 extends the fillet 100 upstream.

The outer leg 104 defines a generally frustoconical outer surface 110 widening in the downstream direction, and internally delimiting part of the outer duct 52. The outer leg 104 has a greater axial extension than the inner leg 102. Given that the two legs 102, 104 have the same upstream limit (they both terminate at the upstream end 105 of the ring 94), this means that the outer leg 104 projects downstream relative to the inner leg 102. In particular, the outer leg 104 also projects downstream relative to the ferrule 92.

Here, the upstream end 105 defines a radial shoulder 112, which is substantially planar and lies in a radial plane, facing upstream.

The ring 94 also comprises a hook-shaped appendage 114 extending the outer leg 104 downstream. The appendage 114 is curved outwards. It has an upstream end 116 connected to the outer leg 104 and a free downstream end 118. The distance from the downstream end 118 to the axis X is less than or equal to the distance from the upstream end 116 to the axis X; in the example shown, the two distances are substantially equal to each other. The appendage 114 provides a seal between the fan rotor 54 and the casing 119 (FIG. 2) of the nacelle 20.

The ring 94 further comprises a reinforcing core 120 interposed between the legs 102, 104. Said core 120 is housed at the bottom of the space 122 between the legs 102, 104, i.e. it comes up against the upstream end 105 of the ring 94.

In particular, the rotating spacer ring 90 is formed by an upstream skin 122, a downstream skin 123 and an annular insert 124.

The upstream skin 122 forms an upstream part of the ferrule 92 and an upstream part of the fillet 100, as well as the inner leg 102, the upstream end 105 and an outer portion of the outer leg 104 of the ring 94. The upstream skin 122 thus delimits an upstream face 126 of the rotating spacer ring 90.

The downstream skin 123 forms a downstream portion of the ferrule 92 and a downstream portion of the fillet 100, as well as the appendage 114 and an inner portion of the outer leg 104 of the ring 94. It also extends between the inner and outer legs 102, 104 downstream of the core 120. The downstream skin 123 thus delimits a downstream face 128 of the rotating spacer ring 90.

The insert 124 is housed between the skins 122, 123. It forms the core 120.

The skins 122, 123 and insert 124 are each formed from a composite material comprising fibres embedded in a matrix. The fibres of the insert 124 are preferably predominantly oriented in the circumferential direction (i.e. orthogonal to the axial and radial directions) so as to withstand the circumferential and radial loads during rotation of the fan rotor 54.

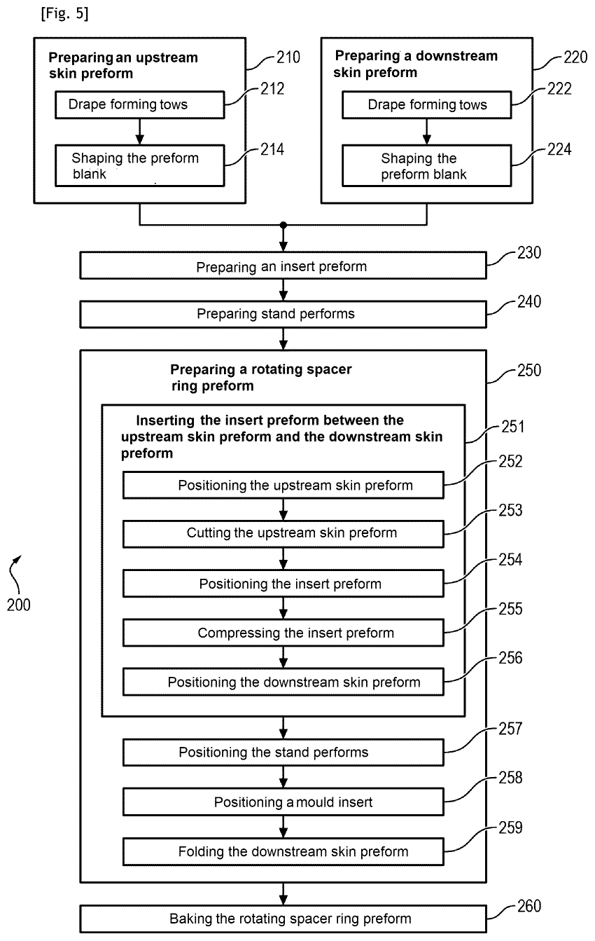

A method 200 for manufacturing the rotating spacer ring 90 will now be described, with reference to FIGS. 5 to 25.

As can be seen in FIG. 5, the method 200 comprises a first step 210 of preparing an upstream skin preform 300 (FIG. 18). This step 210 begins with drape forming 212 of prepreg tows by automatic fibre placement.

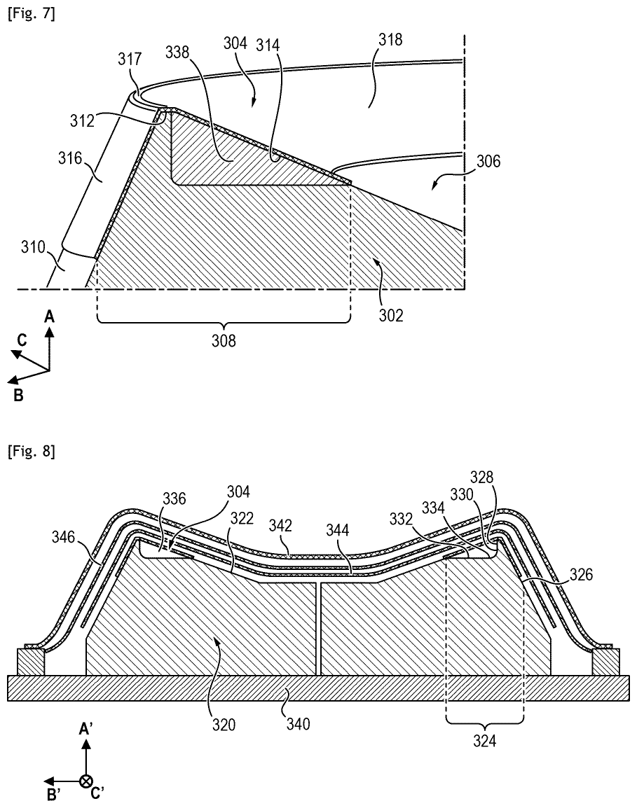

As can be seen in FIG. 7, said prepreg tows are drape formed over a first upstream skin mould 302 so as to produce an annular upstream skin preform blank 304.

The first upstream skin mould 302 has a rotationally symmetric shape centred on an axis of revolution (not shown). For the remainder of the description, the orientation terms are understood to refer to a cylindrical reference frame associated with the first upstream skin mould 302, shown in FIG. 7, in which it is possible to distinguish at each point:
an axial direction A parallel to the axis of revolution, running from rear to front,
a radial direction B, orthogonal to the axial direction A, joining the axis of revolution to said point and running from the inside towards the outside, and
a circumferential direction C orthogonal to the axial A and radial B directions.

The first upstream skin mould 302 has a front face 306 with a convex outer annular edge 308. Said outer annular edge 308 comprises a frustoconical outer portion 310 widening towards the rear, a substantially planar annular intermediate portion 312 extending substantially in a radial plane and projecting inwardly from a forward end of the outer portion 310, and an inner portion 314 extending inwardly from the intermediate portion 312, said inner portion 314 being in the shape of a truncated cone widening towards the front. T

he prepreg tows are drape formed over the outer annular edge 308. In this way, they are drape formed over a convex surface, which is highly suitable for automatic fibre placement, as the laying head of a drape forming machine cannot press the prepreg tows against a support having a concave shape when said concave shape has a radius of curvature smaller than that of the laying head roller.

In particular, each prepreg tow is drape formed in a direction (not shown) forming at each point a non-zero angle with the local circumferential direction C, said angle preferably being between 25° and 90°. In other words, the drape forming direction of each prepreg tow has a radial component at every point.

Preferably, different layers of prepreg tows are drape formed successively so that the upstream skin preform blank 304 is formed from a stack of several plies stacked along the axial direction A. Advantageously, the orientation of the drape forming direction of the tows alternates from one layer to the next. For example, the drape forming direction of the tows in the even (respectively odd) layers is oriented substantially at 90° to the circumferential direction C, the drape forming direction of the tows in the odd (respectively even) layers being oriented substantially at 30° to the circumferential direction C.

The upstream skin preform blank 304 thus comprises:
a frustoconical outer portion 316 widening towards the rear, corresponding to the outer portion of the outer leg 104 of the ring 94, and
an annular, substantially planar intermediate portion 317 projecting inwardly from a front end of the outer portion 316, said intermediate portion 317 corresponding to the upstream end 105 of the ring 94.

On the other hand, the upstream skin preform 304 does not comprise a portion corresponding to the inner leg 102 of the ring 94, the upstream portion of the fillet 100 or the upstream portion of the ferrule 92. Instead, it comprises an inner portion 318 extending inwardly from the intermediate portion 317, said inner portion 318 being in the shape of a truncated cone widening towards the front.

The drape forming 212 is thus followed by a step 214 of shaping the upstream skin preform blank 304 to form the parts corresponding to the inner leg 102 of the ring 94, the upstream part of the fillet 100 and the upstream part of the ferrule 92 and thus obtaining the upstream skin preform 300.

This shaping is done, for example, by vacuum thermoforming. For this purpose, the upstream skin preform blank 304 is, as can be seen in FIG. 8, placed on a second upstream skin mould 320. This second upstream skin mould 320 has a rotationally symmetric shape centred on an axis of revolution (not shown). For the remainder of the description, the orientation terms are understood to refer to a cylindrical reference frame associated with the second upstream skin mould 320, shown in FIG. 8, in which it is possible to distinguish at each point:
an axial direction A′ parallel to the axis of revolution, running from rear to front,
a radial direction B′, orthogonal to the axial direction A′, joining the axis of revolution to said point and running from the inside towards the outside, and
a circumferential direction C′ orthogonal to the axial A′ and radial B′ directions.

In a similar manner to the first upstream skin mould 302, the second upstream skin mould 320 has a front face 322 with a convex outer annular edge 324, said outer annular edge 324 comprising a frustoconical outer portion 326 widening towards the rear, and a substantially planar annular intermediate portion 328 extending substantially in a radial plane and projecting inwardly from a front end of the outer portion 326. In particular, the outer portion 326 and the intermediate portion 328 are substantially identical and advantageously perfectly identical to the outer portion 310 and the intermediate portion 312 respectively of the first upstream skin mould 302.

Unlike the first upstream skin mould 302, the outer annular edge 324 of the second upstream skin mould 320 does not comprise a frustoconical inner portion widening towards the front. Instead, said outer annular edge 324 comprises:
a cylindrical portion 330 extending towards the rear from an inner end of the intermediate portion 328,
a substantially planar annular inner portion 332 extending substantially in a radial plane and delimiting an inner end of the outer annular edge 324, and
an annular fillet 334 connecting the cylindrical portion 330 to the inner portion 332.

The cylindrical portion 330, the inner portion 332 and the annular fillet 334 together delimit a concave recess 336 in the front face 322, i.e. the surface resulting from the combination of these three regions 330, 332, 334 is recessed relative to the surface connecting the inner end of the intermediate portion 328 to the inner end of the outer annular edge 324.

The outer annular edge 324 thus has the shape of the upstream skin 122.

Advantageously, the second upstream skin mould 320 is obtained from the first upstream skin mould 302 by removing an insert 338 (FIG. 7) filling the recess 336 and defining the inner portion 314 of the outer annular edge 308 of the front face 306 of the first upstream skin mould 302.

The second upstream skin mould 320 is placed on a forming platform 340, then the upstream skin preform blank 304 is covered with a bladder 342 with preferably a separator 344 and a drain 346 interposed between the upstream skin preform blank 304 and the bladder 342. The seal is produced between the bladder 342 and the forming platform 340, then the assembly is heated, typically to a temperature of between 80 and 90° C., while the vacuum is created between the bladder 342 and the forming platform 340. The bladder 342 is thus pressed against the second upstream skin mould 320 and carries with it the upstream skin preform blank 304, softened by the heat, which thus takes the shape of the outer annular edge 324 of the upstream face 322 of said mould 320.

Thus the upstream skin preform 300 is obtained.

Returning to FIG. 5, the manufacturing method 200 also comprises a second step 220 of preparing a downstream skin preform 350 (FIG. 22). This second step 220 is implemented in parallel with the first step 210. Alternatively, it is implemented after the first step 210, or even before said first step 210.

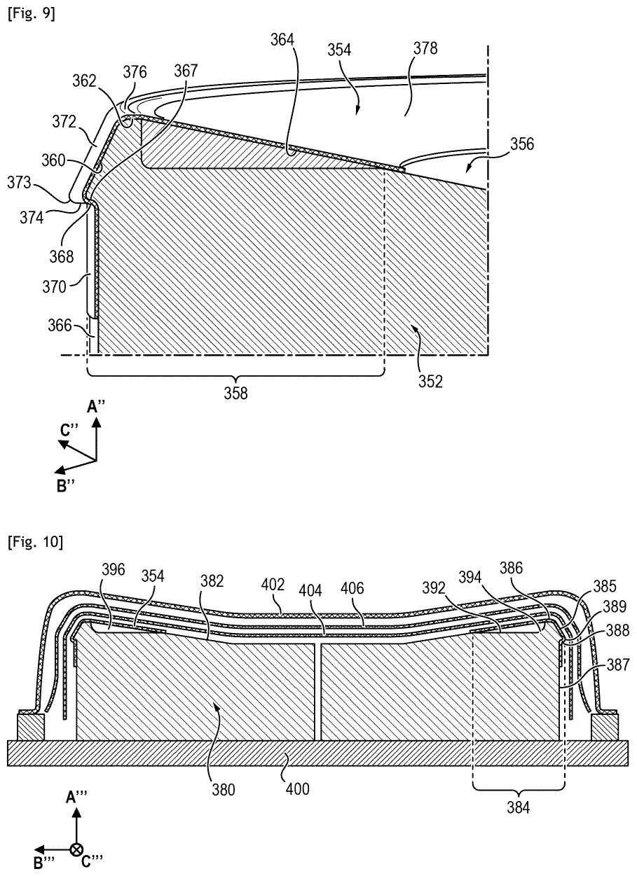

In a similar way to the first step 210, the second step 220 begins with a drape forming 222 of prepreg tows by automatic fibre placement. As shown in FIG. 9, said prepreg tows are drape formed over a first downstream skin mould 352 to produce an annular downstream skin preform blank 354.

The first downstream skin mould 352 has a rotationally symmetric shape centred on an axis of revolution (not shown). For the remainder of the description, the orientation terms are understood to refer to a cylindrical reference frame associated with the first downstream skin mould 352, shown in FIG. 9, in which it is possible to distinguish at each point:
an axial direction A″ parallel to the axis of revolution, running from rear to front,
a radial direction B″, orthogonal to the axial direction A″, joining the axis of revolution to said point and running from the inside towards the outside, and
a circumferential direction C″ orthogonal to the axial A″ and radial B″ directions.

The first downstream skin mould 352 has a front face 356 with a convex outer annular edge 358. Said outer annular edge 358 comprises a frustoconical outer portion 360 widening towards the rear, a substantially planar annular intermediate portion 362 extending substantially in a radial plane and projecting inwardly from a forward end of the outer portion 360, and an inner portion 364 extending inwardly from the intermediate portion 362, said inner portion 364 being in the shape of a truncated cone widening towards the front.

The first downstream skin mould 352 also has an outer cylindrical face 366. This outer cylindrical face 366 has a smaller diameter than the outer diameter of the front face 356. A collar 367 delimiting a shoulder 368 facing rearwards ensures the junction between the outer cylindrical face 366 and the front face 356.

The prepreg tows are drape formed over said outer annular edge 358 and over a front end section 370 of the outer cylindrical face 366. As a result, they are essentially drape formed over a convex surface, which as we have seen is highly suitable for automatic fibre placement. If said tows are also drape formed over a concave surface, at the interface between the front face 356 and the outer cylindrical face 366, this does not pose any difficulty in view of the small size of the surface concerned: it is in fact not a problem, over such a small surface, for the tows not to be pressed against the mould 352.

In particular, each prepreg tow is drape formed in a direction (not shown) forming at each point a non-zero angle with the local circumferential direction C″, said angle preferably being between 25° and 90°. In other words, the drape forming direction of each prepreg tow has a radial component at every point.

Preferably, different layers of prepreg tows are drape formed successively along the axial direction A″ so that the downstream skin preform blank 354 is formed from an axial stack of several plies. Advantageously, the orientation of the drape forming direction of the tows alternates from one layer to the next. For example, the drape forming direction of the tows in the even (respectively odd) layers is oriented substantially at 90° to the circumferential direction C″, the drape forming direction of the tows in the odd (respectively even) layers being oriented substantially at 30° to the circumferential direction C″.

The downstream skin preform blank 354 thus comprises:
a rear 370 cylindrical portion extending axially,
a frustoconical outer portion 372, widening towards the rear, to a rear end 373 having a diameter greater than that of the rear portion 370, said outer portion 372 corresponding to the inner portion of the outer leg 104 of the ring 94,
a substantially planar collar 374 extending substantially in a radial plane, said collar 374 connecting a front end of the rear portion 370 to the rear end 373 of the outer portion 372, said collar 374 corresponding to the upstream end 116 of the appendage 114 of the ring 94, and
a substantially planar, annular intermediate portion 376 projecting inwards from a front end of the outer portion 372, said intermediate portion 374 corresponding to the portion of the downstream skin 123 which extends between the inner and outer legs 102, 104 of the ring 94 downstream of the core 120.

In contrast, the downstream skin preform blank 354 does not comprise a portion corresponding to the downstream portion of the fillet 100 or the downstream portion of the ferrule 92. Instead, it comprises an inner portion 378 extending inwardly from the intermediate portion 376, said inner portion 378 being in the shape of a truncated cone widening towards the front. In particular, the angle at the apex of this inner portion 378 is greater than that of the inner portion 318 of the upstream skin preform blank 304.

The drape forming 222 is thus followed by a step 224 of shaping the downstream skin preform blank 354 to form the parts corresponding to the downstream portion of the fillet 100 and the downstream portion of the ferrule 92 and thus obtaining the downstream skin preform 350.

This shaping is done, for example, by vacuum thermoforming. For this purpose, the downstream skin preform blank 354 is, as can be seen in FIG. 10, placed on a second downstream skin mould 380. This second downstream skin mould 380 has a rotationally symmetric shape centred on an axis of revolution (not shown). For the remainder of the description, the orientation terms are understood to refer to a cylindrical reference frame associated with the second downstream skin mould 380, shown in FIG. 10, in which it is possible to distinguish at each point:

an axial direction A″ parallel to the axis of revolution, running from rear to front
a radial direction B″, orthogonal to the axial direction A″, joining the axis of revolution to said point and running from the inside towards the outside, and
a circumferential direction C″ orthogonal to the axial A″ and radial B″ directions.

In a similar manner to the first downstream skin mould 352, the second downstream skin mould 380 has a front face 382 with a convex outer annular edge 384, said outer annular edge 384 comprising a frustoconical outer portion 385 widening towards the rear, and a substantially planar annular intermediate portion 386 extending substantially in a radial plane and projecting inwardly from a front end of the outer portion 385. The second downstream skin mould 380 also has an outer cylindrical face 387 with a diameter smaller than the outer diameter of the front face 382 and a collar 388 which delimits a shoulder 389 facing rearwards, and ensures the junction between the outer cylindrical face 387 and the front face 382.

In particular, the outer portion 385, the intermediate portion 386, the outer cylindrical face 387 and the collar 388 are substantially identical and advantageously perfectly identical respectively to the outer portion 360, the intermediate portion 362, the outer cylindrical face 366 and the collar 367 of the first downstream skin mould 352.

Unlike the first downstream skin mould 352, the outer annular edge 384 of the second downstream skin mould 380 does not comprise a frustoconical inner portion widening towards the front. Instead, said outer annular edge 384 comprises:
a substantially planar annular inner portion 392 extending substantially in a radial plane, set back from the intermediate portion 386 and delimiting an inner end of the outer annular edge 384, and an annular fillet 394 connecting the inner portion 392 to an inner end of the intermediate portion 386.

The inner portion 392 and the annular fillet 394 together delimit a concave recess 396 in the front face 382, i.e. the surface resulting from the combination of these two regions 392, 394 is recessed relative to the surface connecting the inner end of the intermediate portion 386 to the inner end of the outer annular edge 384.

The outer annular edge 384 thus has the shape of the downstream skin 123.

Advantageously, the second downstream skin mould 380 is obtained from the first downstream skin mould 352 by removing an insert 398 (FIG. 9) filling the recess 396 and defining the inner portion 364 of the outer annular edge 358 of the front face 356 of the first downstream skin mould 352.

The second upstream skin mould 380 is placed on a forming platform 400, then the downstream skin preform blank 354 is covered with a bladder 402 with preferably a separator 404 and a drain 406 interposed between the downstream skin preform blank 354 and the bladder 402. The seal is produced between the bladder 402 and the forming platform 400, then the assembly is heated, typically to a temperature of between 80 and 90° C., while the vacuum is created between the bladder 402 and the forming platform 400. The bladder 402 is thus pressed against the second downstream skin mould 380 and carries with it the upstream skin preform blank 354, softened by the heat, which thus takes the shape of the outer annular edge 384 of the upstream face 382 of said mould 380.

Thus the downstream skin preform 350 is obtained.

Returning to FIG. 5, the manufacturing method 200 again comprises a third step 230 of preparing an insert preform 410 (FIG. 20). This third step 230 is implemented after the first and second steps 210, 220. Alternatively (not shown), it is implemented in parallel with said steps 210, 220, or between said steps 210, 220, or even before said steps 210, 220.

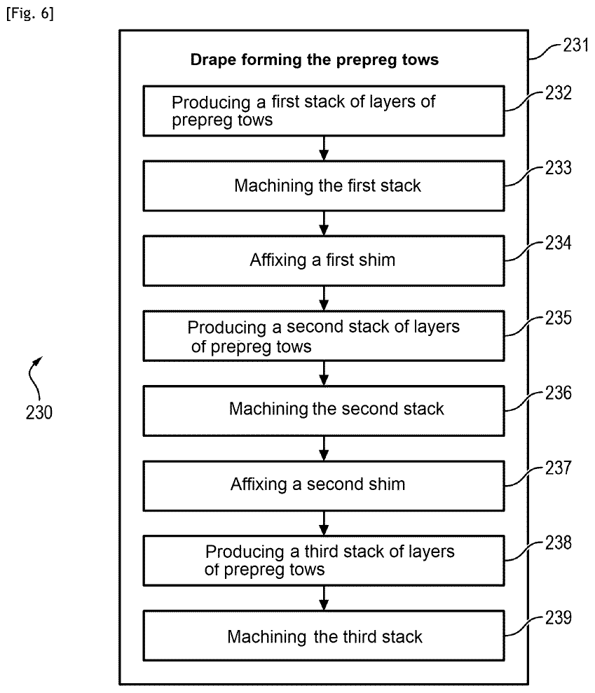

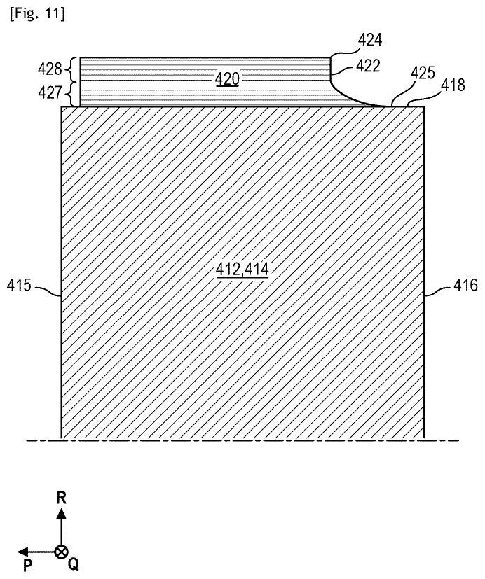

With reference to FIG. 6, this third step 230 comprises drape forming 231 of prepreg tows over an insert mould 412 (FIG. 11) by automatic fibre placement. As can be seen in FIG. 11, the insert mould 412 has a disc shape 414 comprising two opposing large discoidal faces 415, 416 joined together by a circumferential rim 418. In particular, this disc 414 is rotationally symmetric about a central axis (not shown). For the remainder of the description, the orientation terms are understood to refer to a cylindrical reference frame associated with the insert mould 412, shown in FIG. 11, in which it is possible to distinguish at each point:
an axial direction P parallel to the central axis, running from rear to front,
a radial direction R, orthogonal to the axial direction P, joining the central axis to said point and running from the inside towards the outside, and
a circumferential direction Q orthogonal to the axial P and radial R directions.

During said drape forming 231, the prepreg tows are drape formed over the rim 418 of the disc 414 substantially parallel to the circumferential direction Q, i.e. in a direction forming an angle of less than 5°, or even less than 1°, with said circumferential direction Q. Thus, the fibres of the insert 124 are predominantly oriented in the circumferential direction, which enables the insert 124 to withstand high circumferential and radial loads during rotation of the fan rotor 54.

Returning to FIG. 6, drape forming 231 begins with a first sub-step 232 of producing a first stack 420 (FIG. 11) of layers of prepreg tows.

During this first sub-step 232, the prepreg tows are drape formed in successive layers in the radial direction R. A first layer (not referenced) is first drape formed directly over the rim 418 of the mould 412, then each subsequent layer is drape formed over the outer face of the preceding layer. For example, between 40 and 60 layers are drape formed successively to form this first stack 420.

The axial position of each layer is defined by reference to a first axial edge 422, in this case a rear edge, of the first stack 420. In other words, the layers are positioned axially relative to one another so that the first axial edge 422 of the first stack 420 has a predefined radial profile, i.e. is taken in a radial plane. In particular, the layers are positioned so that said first axial edge 422 has an axial extension with advantageously, as shown, an outer end 424 of the first axial edge 422 axially set back with respect to the inner end 425 of the first axial edge 422. In other words, the outer end 424 of the first axial edge 422 is offset axially forwards with respect to the inner end 425.

More particularly, the layers are positioned so that the first stack 420 comprises an inner section 427 in which the first axial edge 422 has an axial extension and an outer section 428 in which the first axial edge 422 extends substantially in a radial plane, i.e. the axial extension of the first axial edge 422 in this outer section 428 is substantially zero. The inner section 427 delimits an inner end (not referenced) of the first stack 420 and the outer section 428 delimits an outer end (not referenced) of the first stack 420. The radial profile of the first axial edge 422 is substantially continuous and derivable at the junction between said inner and outer sections 427, 428. In the inner section 427, the radial profile of the first axial edge 422 is concave with a concavity directed radially outwards.

The inner 427 and outer 428 sections have substantially the same radial thickness.

Advantageously, the prepreg tows are disposed in a staggered manner in the outer section 428. For this purpose, the outer section 428 has alternating layers that are axially offset relative to one another, said layers being offset alternately forwards and backwards. In other words, the outer section 428 includes a plurality of first layers aligned radially with one another, with interposed between them second layers offset axially forwards or backwards relative to the first layers, said second layers themselves being aligned radially with one another. This axial offset is typically between 1 and 2 mm and is, for example, substantially equal to 1.5 mm. Thus, alignment of the spaces between the tows is avoided, which alignment could lead to brittleness within the insert 410.

Preferably, the radially aligned layers are grouped in groups of at least two layers, for example three layers, stacked successively with no radially offset layer in between.

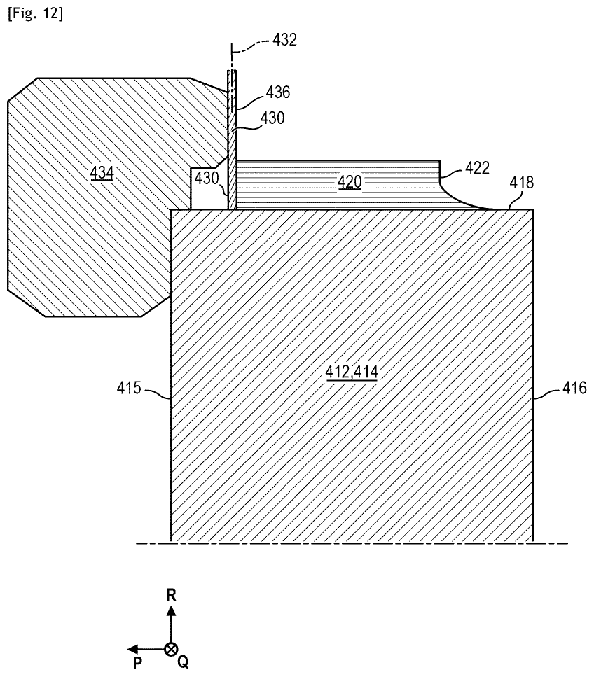

Returning to FIG. 6, sub-step 232 is followed by a sub-step 233 of machining the first stack 420. As can be seen in FIG. 12, during this sub-step 233, the axial edge of the first stack 420 that is opposite the axial edge defined by drape forming 422, in this case the front edge, is machined, thus forming a first machined axial edge 430. In particular, this machining is carried out by clean cutting of the first stack 420 along a first radial cutting surface 432 by means of a cutting tool 434 having a blade 436 extending along said first cutting surface 432.

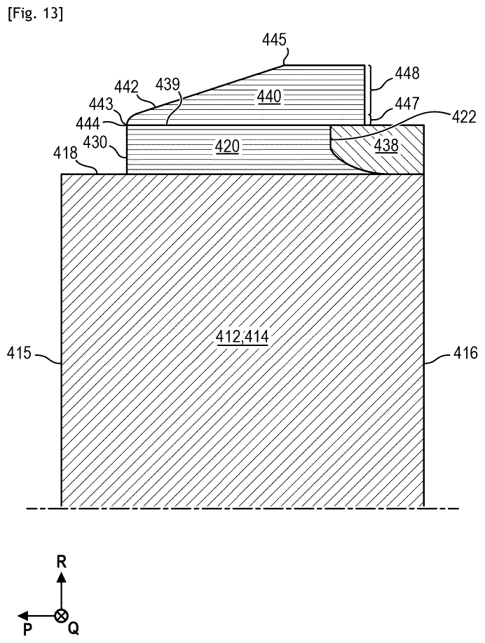

Returning to FIG. 6, sub-step 233 is followed by a sub-step 234 of affixing a shim 438 (FIG. 13) along the axial edge defined by drape forming 422. As can be seen in FIG. 13, said shim 438 is placed on the rim 418 of the mould 412 and follows the shape of the axial edge defined by drape forming 422. It has substantially the same radial thickness as the first stack 420 and is flush with an outer face 439 of the first stack 420.

Returning to FIG. 6, sub-step 234 is followed by a sub-step 235 of producing a second stack 440 (FIG. 13) of layers of prepreg tows on top of the first stack 420.

During this sub-step 235, the prepreg tows are drape formed in successive layers in the radial direction R, straddling the first stack 420 and the shim 438. A first layer (not referenced) is first drape formed directly over the first stack 420 and the shim 438, then each subsequent layer is drape formed over the outside of the preceding layer. For example, between 40 and 60 layers are drape formed successively to form this second stack 440.

The axial position of each layer is defined by reference to a first axial edge 442, in this case a front edge, of the second stack 440. In other words, the layers are positioned axially relative to one another so that the first axial edge 442 of the second stack 440 has a predefined radial profile, i.e. is taken in a radial plane. This first axial edge 442 extends one of the axial edges 422, 430, in this case the machined axial edge 430, of the first stack 420, i.e. the inner end 443 of the first axial edge 442 is flush with the outer end 444 of the machined axial edge 430.

In particular, the layers are positioned so that said first axial edge 442 has an axial extension with advantageously, as shown, an outer end 445 of the first axial edge 442 axially set back with respect to the inner end 443 of the first axial edge 442. In other words, the outer end 445 of the first axial edge 442 is offset axially rearwards with respect to the inner end 443. In particular, the outer end 445 is interposed axially between the inner end 443 and the shim 438.

More particularly, the layers are positioned so that the first axial edge 442 has no concave section with an inwardly directed concavity, i.e. so that no layer is offset axially forwards relative to the lower layer. In addition, the layers are positioned so that each section of the first axial edge 442 has an axial extension, i.e. the second stack 440 does not have a section in which the first axial edge 442 extends substantially in a radial plane.

In the example shown, the layers are positioned so that the second stack 440 comprises an inner section 447 in which the first axial edge 442 is convex with a convexity directed radially outwards and an outer section 448 in which the first axial edge 442 is substantially frustoconical in shape, centred on the central axis. In the inner section 447, the radial profile of the first axial edge 442 is in particular substantially in the shape of a circular arc. In particular, the inclination of the first axial edge in section 448 is substantially equal to the inclination of the outer surface 110 of the rotating spacer ring 90 and forms, for example, an angle of between 20° and 45° with the rim 418 of the mould 412.

The radial profile of the first axial edge 442 is substantially continuous and derivable at the junction between said inner and outer sections 447, 448.

Returning to FIG. 6, sub-step 235 is followed by a sub-step 236 of machining the second stack 440. As can be seen in FIG. 14, during this sub-step 236, the axial edge of the second stack 440 that is opposite the axial edge defined by drape forming 442, in this case the rear edge, is machined, thus forming a second machined axial edge 450. In particular, this machining is carried out by clean cutting of the second stack 440 along a second radial cutting surface 452 by means of a cutting tool 454 having a blade 456 traversing said second cutting surface 452.

This second cutting surface 452 is different from the first cutting surface 432. In particular, it is axially offset relative to the first cutting surface 432. It radially extends the axial edge defined by drape forming 422 of the first stack 420, i.e. it intersects the outer face 439 of the first stack 420 at said axial edge 422.

Preferably, the shim 438 is removed prior to implementing sub-step 236.

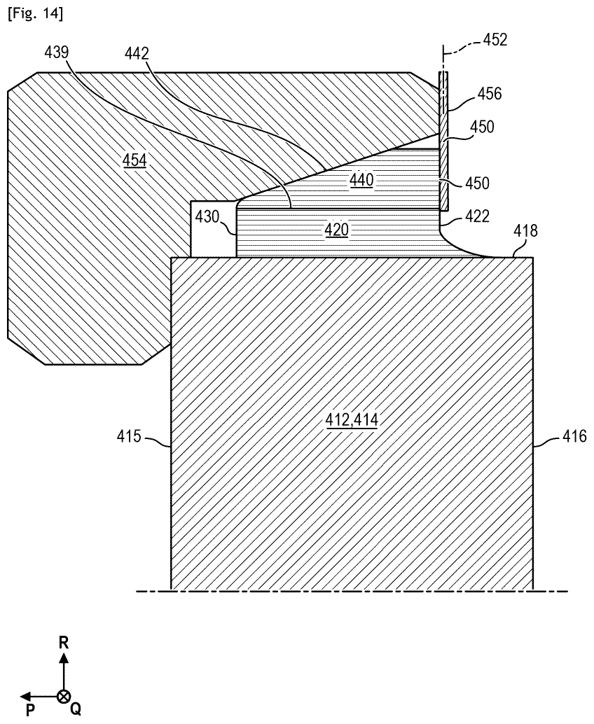

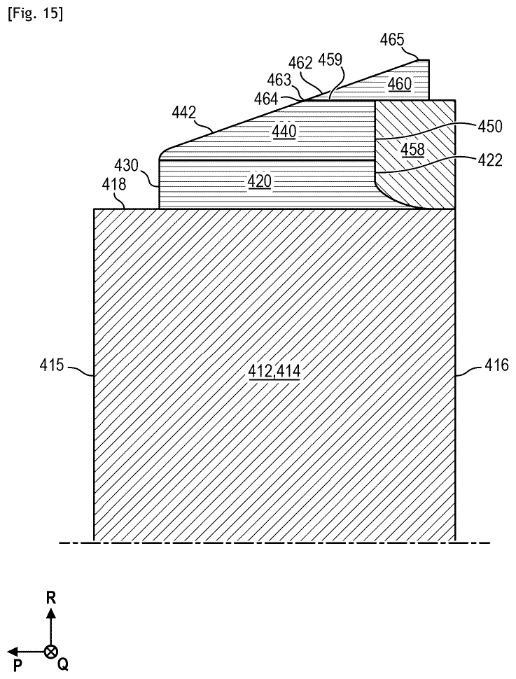

Returning to FIG. 6, sub-step 236 is followed by a sub-step 237 of affixing a shim 458 (FIG. 15) along the second machined axial edge 440. As can be seen in FIG. 15, said shim 458 is placed on the rim 418 of the mould 412 and follows the shape of the axial edge defined by drape forming 422 of the first stack 420 and the second machined axial edge 440. It has substantially the same radial thickness as the first stack 420 and the second stack 440 taken together and is flush with an outer face 459 of the second stack 440.

Returning to FIG. 6, sub-step 237 is followed by a sub-step 238 of making a third stack 460 (FIG. 15) of layers of prepreg tows on top of the second stack 440.

During this sub-step 237, the prepreg tows are drape formed in successive layers in the radial direction R, straddling the second stack 440 and the shim 458. A first layer (not referenced) is first drape formed over the second stack 440 and the shim 458, then each subsequent layer is drape formed over the outer face of the preceding layer. For example, between 40 and 60 layers are drape formed successively to form this third stack 460.

The axial position of each layer is defined by reference to a first axial edge 462, in this case a front edge, of the third stack 460. In other words, the layers are positioned axially relative to one another so that the first axial edge 462 of the third stack 460 has a predefined radial profile, i.e. is taken in a radial plane. This first axial edge 462 extends one of the axial edges 442, 450, in this case the axial edge defined by drape forming 442, of the second stack 440, i.e. the inner end 463 of the first axial edge 462 is flush with the outer end 464 of the axial edge defined by drape forming 442.

In particular, the layers are positioned so that said first axial edge 462 has an axial extension with advantageously, as shown, an outer end 465 of the first axial edge 462 axially set back with respect to the inner end 463 of the first axial edge 462. In other words, the outer end 465 of the first axial edge 462 is offset axially rearwards with respect to the inner end 463. In particular, the outer end 465 is located radially above the shim 458, i.e. the radial plane passing through the outer end 465 intersects the shim 458.

More particularly, the layers are positioned so that the first axial edge 462 has no concave section with an inwardly directed concavity, i.e. so that no layer is offset axially forwards relative to the lower layer. Moreover, the layers are positioned so that each section of the first axial edge 462 has an axial extension, i.e. the third stack 460 does not have a section in which the first axial edge 462 extends substantially in a radial plane.

In the example shown, the first axial edge 462 is substantially frustoconical in shape, centred on the central axis. Its inclination is, in particular, substantially equal to the inclination of the outer surface 110 of the rotating spacer ring 90 and forms, for example, an angle of between 20° and 45° with the rim 418 of the mould 412.

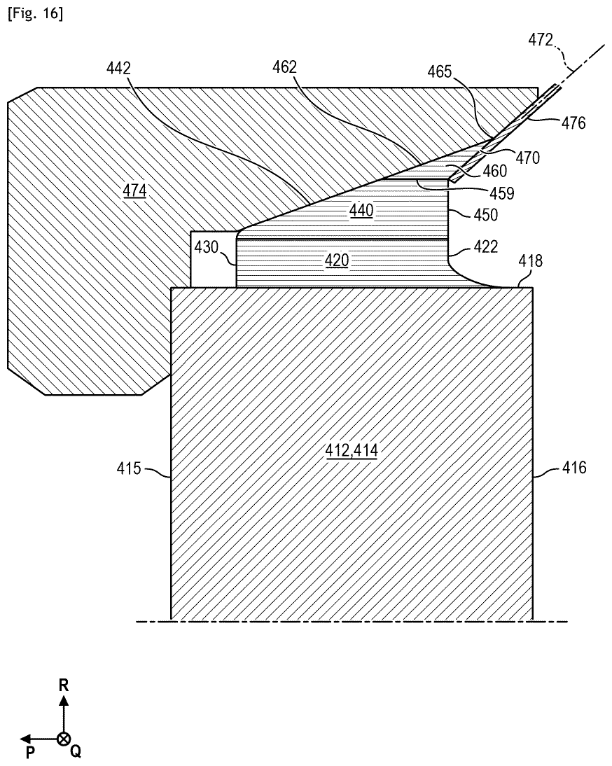

Returning to FIG. 6, sub-step 238 is followed by a sub-step 239 of machining the third stack 460. As can be seen in FIG. 16, during this sub-step 239, the axial edge of the third stack 460 that is opposite the axial edge defined by drape forming 462, in this case the rear edge, is machined, thus forming a third machined axial edge 470. In particular, this machining is carried out by clean cutting of the third stack 460 along a third radial cutting surface 472 by means of a cutting tool 474 having a blade 476 traversing said third cutting surface 472.

This third cutting surface 472 is different from the first and second cutting surfaces 432, 452. In particular, this third cutting surface 472 is a frustoconical surface centred on the central axis and widening towards the rear. It radially extends the axial edge defined by drape forming 442 of the second stack 440, i.e. it intersects the outer face 459 of the second stack 440 at said axial edge defined by drape forming 442, and intersects the outer end 465 of the axial edge defined by drape forming 462 of the third stack 460.

Preferably, the shim 458 is removed before this sub-step 239 is implemented.

Thus, the insert preform 410 is obtained.

It should be noted that, through sub-steps 232 to 239, this insert preform 410, of small dimensions and complex shape, is obtained without implementing a complex cutting strategy. More specifically, the insert preform 410 is simply divided into a plurality of concentric regions 420, 440, 460, each having a planar or frustoconical axial edge, and, for each of these regions 420, 440, 460, the axial edge having the most complex geometry (for example because it is curved while the other edge is straight, or because it is inclined while the other edge is radial) is formed directly during drape forming, simply by programming the robot so as to offset the strips from one layer to the other, which is done very easily. It then suffices to machine the opposite axial edge by a clean cut, in order to obtain a planar or frustoconical axial edge. This cutting of one of the two axial edges remains necessary, as the tows have a fixed width (typically 6.35 mm) which is the same for all the layers and which is not small compared to the width of the insert preform 410 (each layer is formed by only a few tows placed side by side, the number of these tows typically being between 1 and 20 and more often between 3 and 9). It is therefore not possible, during drape forming, to adapt the distance between the axial edges by adjusting the width of the tows or the number of tows deposited in each layer. As a result, at the end of each production 232, 235, 238 of a stack of layers, the axial edge which is opposite the edge defined by drape forming is left with substantially the same geometry as the edge defined by drape forming (this aspect is not shown in FIGS. 11, 13 and 15, which are schematic, nevertheless, in practice, the two axial edges in question do indeed have substantially the same geometry). To give this axial edge the desired geometry, which is different from that of the edge defined by drape forming, said axial edge is machined.

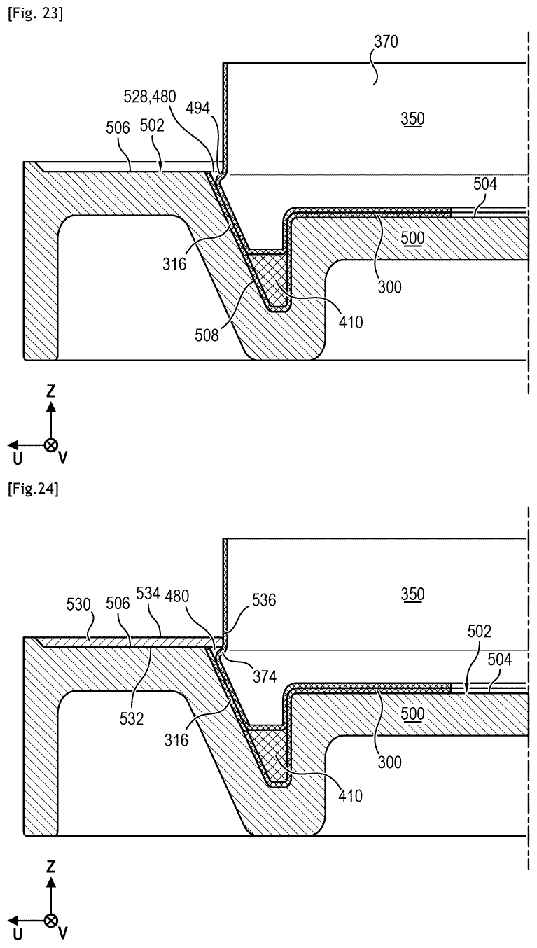

Returning to FIG. 5, the method further comprises, in the example shown, a fourth step 240 of preparing strand preforms 480 (FIG. 23). This fourth step 240 is implemented in this case after the first, second and third steps 210, 220, 230. Alternatively (not shown), it is implemented in parallel with said steps 210, 220, 230, or between said steps 210, 220, 230, or even before said steps 210, 220, 230.

Referring to FIG. 17, in this step 240, prepreg tows 482 are successively stacked in a strand mould 484. This strand mould 484 is curved with an inner radius of curvature substantially equal to the outer radius of the rear end 373 of the outer portion 372 of the downstream skin preform 350. It has a radial cross-section, i.e. taken in a plane orthogonal to the direction of curvature of the mould 484, substantially in the shape of a V widening out from a bottom 486 to an opening 488. It is delimited between two walls 490, 492 converging towards the bottom 486, each wall 490, 492 extending from the opening 488 to the bottom 486. A first wall 490 has a substantially rectilinear radial profile. The second wall 492 has a radial profile in the shape of an arc of a circle with a radius of curvature substantially equal to the outer radius of curvature of the fillet 494 (FIG. 22) joining the outer portion 372 and the collar 374 of the downstream skin preform 350.

The tows are evenly compacted in the mould 484, said stacking and compacting steps being repeated until the mould 484 is completely full. The stack of tows is then removed from the mould 484 and a strand preform 480 is thus obtained.

Advantageously, the strand preform 480 does not form a complete ring: the preceding steps are then repeated as many times as necessary to obtain a number of strand preforms 480 sufficient to form a complete ring. Alternatively, the strand preform 480 forms a complete ring; a single strand preform 480 is then produced in step 240.

The prepreg tows used to manufacture the upstream skin preform 300, the downstream skin preform 350, the insert preform 410 and, where applicable, the strand preforms 480 advantageously all have substantially the same composition. Said tows are typically unidirectional fibre tows, said fibres being carbon fibres, for example AS7 fibres, embedded in an epoxy resin, for example an 8552 resin.

Returning to FIG. 5, the method 200 further comprises, subsequent to steps 210, 220, 230, 240, a step 250 of preparing a rotating spacer ring preform 490 (FIG. 25).

This step 250 begins with a sub-step 251 of inserting the insert preform 410 between the upstream skin preform 300 and the downstream skin preform 350.

This sub-step 251 begins by positioning 252 the upstream skin preform 300 in a rotating spacer ring mould 500 (FIG. 18). As can be seen in FIG. 18, this mould 500 has a rotationally symmetric shape about a main axis (not shown). For the remainder of the description, the orientation terms are understood to refer to a cylindrical reference frame associated with the mould 500, shown in FIG. 18, in which it is possible to distinguish at each point:
a vertical direction Z parallel to the main axis, running from bottom to top,
a radial direction U, orthogonal to the vertical direction Z, connecting the main axis to said point and running from the inside towards the outside, and
a circumferential direction V orthogonal to the vertical Z and radial U directions.

In particular, mould 500 has a discoidal shape with an upper face 502, comprising:
a substantially disc-shaped central plate 504,
an annular peripheral plate 506, and
between the central plate 504 and the peripheral plate 506, an annular slot 508 extending downwards relative to the central plate 504 and the peripheral plate 506.

The central plate 504 and the peripheral plate 506 are each substantially orthogonal to the main axis and substantially parallel to each other. The peripheral plate 506 is offset vertically upwards relative to the central plate 504.

The slot 508 is delimited between a substantially cylindrical inner wall 510, centred on the main axis, and a substantially frustoconical outer wall 512 widening in the upward direction, centred on the main axis, said walls 510, 512 converging towards a bottom 514 of the slot 508. The inner wall 510 is connected to the central plate 504 by a fillet 516 with an outer radius of curvature substantially equal to the inner radius of curvature of the fillet 100 of the rotating spacer ring 90.

The central plate 504, the fillet 516, the inner wall 510, the bottom 514 and the outer wall 512 together delimit, in a recess, a surface complementary to the upstream face 126 of the rotating spacer ring 90.

The upstream skin preform 300 is thus positioned in the mould 500 so that its intermediate portion 317 extends into the bottom 514 of the slot 508, its outer portion 316 abutting against the outer wall 512 and extending in part outside the slot 508, above the outer plate 502.

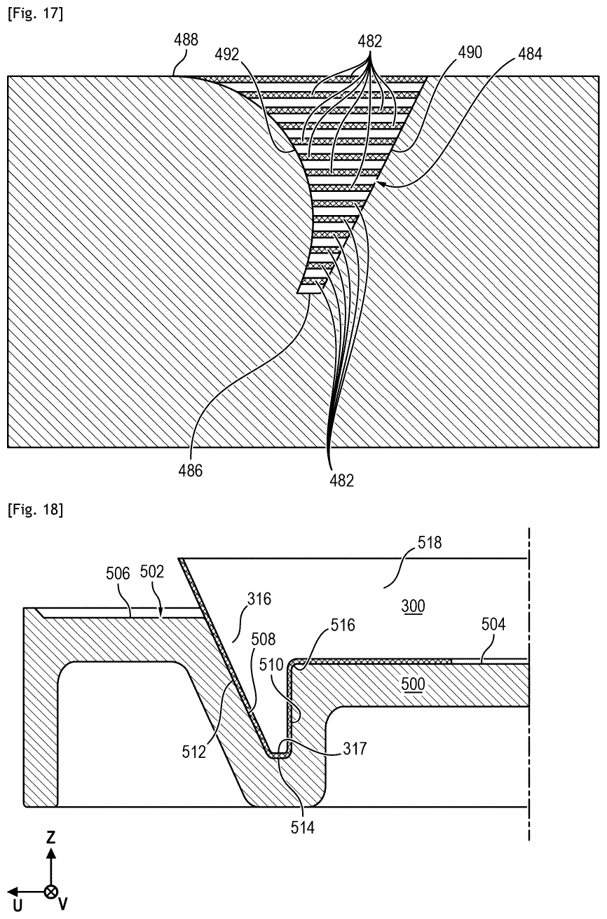

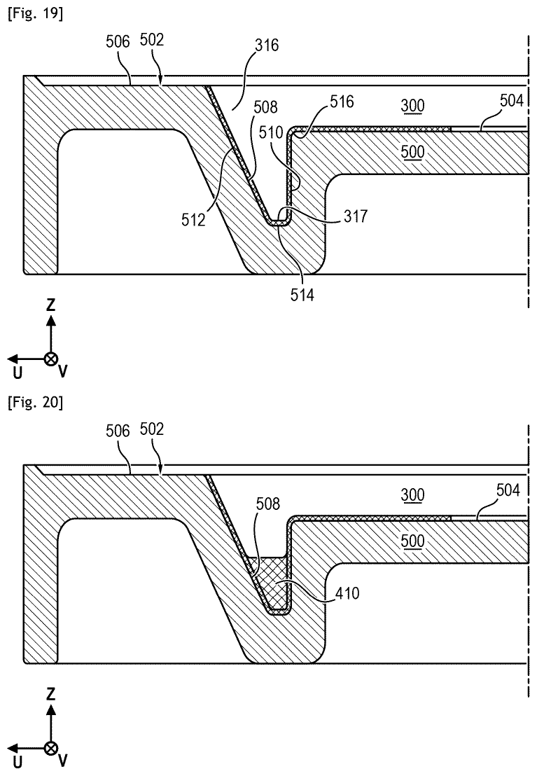

Returning to FIG. 5, sub-step 251 also comprises cutting 253 the upstream skin preform 300. As can be seen in FIG. 19, during this cutting 253, the portion 518 (FIG. 18) of the outer portion 316 of the upstream skin preform 300 which extends outside of the slot 508 is removed.

Still with reference to FIG. 5, sub-step 251 further comprises positioning 254 the insert preform 410. As can be seen in FIG. 20, during this positioning 254, the insert preform 410 is housed in the upstream skin preform 300, at the bottom of the slot 508, with the front face of said preform 410 facing downwards.

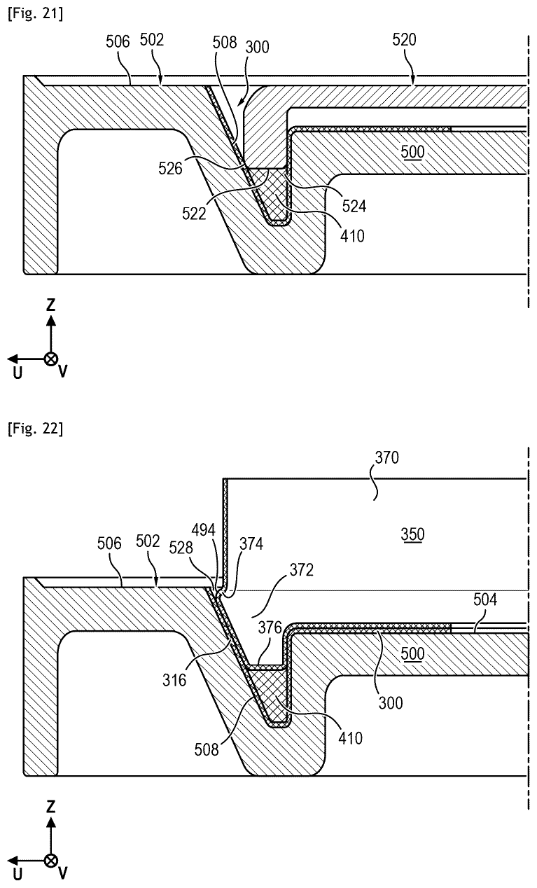

The positioning 254 is followed by compressing 255 the insert preform 410. As can be seen in FIG. 21, during this compressing 255, a punch 520 presses the rear face of the insert preform 410 into the slot 508 so as to compress it into the slot 508. This punch 520 has a flat, downward-facing bearing face 522 with an inner edge 524 and an outer edge 524, each curved upwards. This step enables the rear face of the insert preform 410 to be shaped so that it better matches the downstream skin preform 350.

Compressing 255 is followed by positioning 256 the downstream skin preform 350. As can be seen in FIG. 22, during this positioning 256, the downstream skin preform 350 is placed on top of the upstream skin preform 300 and the insert preform 410, with its front face facing downwards. The outer portion 372 of the downstream skin preform 350 is placed against the outer portion 316 of the upstream skin preform 300 and its intermediate portion 376 is placed against the rear face of the insert preform 410. The rear portion 370 of the downstream skin preform 350 then extends substantially vertically and an annular space 528 remains free between the rear end of the outer portion 316 of the upstream skin preform 300 and the fillet 494 forming the junction between the outer portion 372 and the collar 374 of the downstream skin preform 350.

The insert preform 410 is thus inserted between the upstream skin preform 300 and the downstream skin preform 350.

Sub-step 251 is followed by a sub-step 257 of positioning the strand preforms 480. As can be seen in FIG. 23, in this sub-step 257, the strand preforms 480 are placed in the annular space 528 between the rear end of the outer portion 316 of the upstream skin preform 300 and the fillet 494 of the downstream skin preform 350 so as to fill said annular space 528.

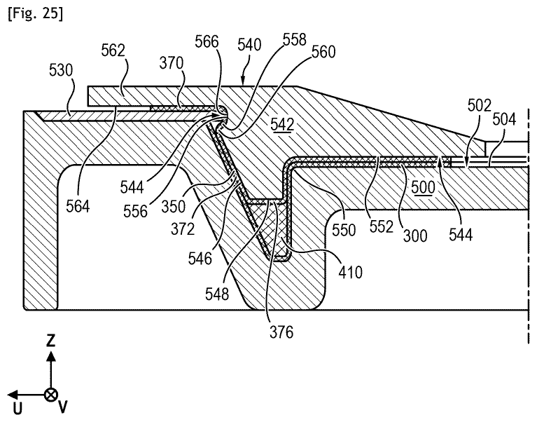

Sub-step 257 is followed by a sub-step 258 of positioning a mould insert 530 (FIG. 24). As can be seen in FIG. 24, in this sub-step 258, a mould insert 530 is placed on the peripheral plate 506. This insert 530 is placed so as to cover the peripheral plate 506, the rear end of the outer portion 316 of the upstream skin preform 300, the strand preforms 480 and the collar 374 of the downstream skin preform 350. It comes into contact with the base of the rear portion 370 of the downstream skin preform 350.

This insert 530 is annular, with an inner radius of curvature substantially equal to the outer radius of curvature of the rear portion 370 of the downstream skin preform 350. It is substantially planar, with a large lower face 532 in contact with the peripheral plate 506, a large upper face 534 opposite the large lower face 532 and substantially parallel to the latter, and an inner edge 536 connecting said large faces 532, 534. The thickness of the insert 530 is substantially equal to the distance between the ends 116, 118 of the appendage 114 of the rotating spacer ring 90.

The insert 530 is advantageously formed of several sectors (not shown) juxtaposed to one another.

Sub-step 258 is finally followed by a sub-step 259 of folding the downstream skin preform 350. As can be seen in FIG. 25, during this sub-step 259 the rear portion 370 of the downstream skin preform 350 is folded outwards over the mould insert 530.

A die 540 is used to enable this folding. This die 540 comprises a core 542 having a lower face 544 comprising, from the outside towards the inside:
a frustoconical outer portion 546, widening in the upward direction,
a substantially planar annular intermediate portion 548 extending substantially in a radial plane and projecting inwardly from a lower end of the outer portion 546,
an annular fillet 550 with a concavity directed inwardly and downwardly, extending upwardly from an inner end of the intermediate portion 548, and
a substantially planar annular inner portion 552, extending substantially in a radial plane set back from the intermediate portion 548, in the extension of an inner end of the fillet 550.

The core 542 also comprises an outer face 554 comprising, from top to bottom:
a cylindrical portion 556 with a diameter smaller than the outer diameter of the lower face 544,
a collar 558 extending radially outwards from a lower end of the cylindrical portion 556 and defining a shoulder facing upwards, and
a fillet 560 with outwardly directed convexity, joining an outer end of the collar 558 to an outer end of the outer portion 546 of the lower face 544.

The core 542 is complementary in shape to the rear face of the downstream skin preform 350.

The die 540 also comprises a folding ring 562. The folding ring 562 projects radially outwards from the core 542, at a distance from the collar 558. It has a substantially planar lower face 564 which, together with the collar 558 and the cylindrical portion 556 of the outer face 554 of the core 542, delimits an outer groove 566, the bottom of which is formed by the cylindrical portion 556. The width of said external groove 566, consisting of the distance from the folding ring 562 to the collar 558, is substantially equal to the thickness of the mould insert 530 increased by twice the thickness of the downstream skin preform 350.

The die 540 is preferably made of silicone. Advantageously, it is made up of several sectors (not shown).

To fold the rear portion 370 of the downstream skin preform 350, the die 540 is positioned so that the groove 566 fits over the inner edge 536 of the mould insert 530, the outer portion 546 and the intermediate portion 548 of the front face 544 of the core 542 abutting against the outer portion 372 and the intermediate portion 376 of the downstream skin preform 350 respectively. In so doing, the folding ring 562 presses against the rear portion 370 of the downstream skin preform 350 and folds it against the mould insert 530.

A rotating spacer ring preform it thus obtained.

Finally, step 250 is followed by a step 260 of baking the rotating spacer ring preform. In this step 260, the rotating spacer ring preform is left in the mould 500, with the mould insert 530 and the die 540 in place, and conventionally heated to a suitable temperature to allow cross-linking of the matrix and curing of the preform. The preform is then cooled and removed from the mould to thus obtain the rotating spacer ring 90.

Since the die 540 is made of silicone, it tends to expand during baking. It therefore presses against the downstream skin preform 350 during curing, which ensures excellent cohesion between the upstream skin 122, the downstream skin 123 and the insert 124 at the end of baking.

Thus, through the method 200 described above, it is possible to obtain a rotating spacer ring 90 made of a composite material with excellent mechanical properties, simply and inexpensively. This method 200 is also easily repeatable, which means that the rotating spacer rings obtained using this method are highly consistent.

In particular, the method 200 cleverly solves the problem of applying the automatic fibre placement drape forming technique to the manufacture of a rotating spacer ring. In particular, thermoforming 214, 224 of the preforms 300, 350 after drape forming 212, 222 solves the problem of managing small concave regions. This thermoforming 214, 224 is made possible by depositing the tows, during drape forming 212, 222, in directions forming non-zero angles with the circumferential direction, even though such an arrangement of the tows is counter-intuitive as it goes against the objective of mechanical strength usually sought for this type of part. This arrangement is itself made possible by the decoupling of the functions of holding the part together and defining the surface as seen by the air flow, entrusted to the skins 122, 123, with the mechanical reinforcement function, entrusted to the insert 124, for which the fibres are deposited in the circumferential direction.

1. A method for manufacturing a spacer ring made of composite material for a turbine engine fan, said spacer ring comprising an upstream skin delimiting an upstream face of the spacer ring when it is mounted on the turbine engine, a downstream skin delimiting a downstream face of the spacer ring when it is mounted on the turbine engine, and an annular insert housed between the upstream and downstream skins, the manufacturing method comprising the following steps:
preparing an upstream skin preform,
preparing a downstream skin preform,
preparing an insert preform,
inserting the insert preform between the upstream skin preform and the downstream skin preform so as to form a spacer ring preform, and
baking the spacer ring preform,
wherein at least one of preparing the upstream skin preform and/or preparing the downstream skin preform comprises drape forming prepreg tows over a skin mould by automatic fibre placement,
wherein preparing-the insert preform comprises drape forming-prepreg tows over an insert mould by automatic fibre placement, the insert mould having a disc shape the prepreg tows being drape formed over a rim of said disc,
wherein the disc is rotationally symmetric about a central axis, a cylindrical reference frame is associated with the insert mould with, at each point, an axial direction parallel to the central axis, a radial direction joining the central axis to said point and a circumferential direction orthogonal to the axial and radial directions, and each prepreg tow is drape formed substantially parallel to the circumferential direction.
wherein drape forming prepreg tows over the insert mould comprises:
producing at least one stack of layers of prepreg tows stacked in the radial direction, said stack having an axial edge defined by drape forming which has an axial extension, and
machining a machined axial edge of the stack, opposite the axial edge defined by drape forming, by clean cutting of the stack.

2. The manufacturing method according to claim 1, wherein drape forming of prepreg tows over the skin mould produces an annular preform blank.

3. The manufacturing method according to claim 1, wherein the skin mould has a rotationally symmetric shape centred on an axis of revolution, a cylindrical reference frame being associated with the skin mould with, at each point, an axial direction parallel to the axis of revolution, a radial direction joining the axis of revolution to said point and a circumferential direction orthogonal to the axial and radial directions, each prepreg tow being drape formed in a direction forming, at each point, a non-zero angle with the local circumferential direction.

4. The manufacturing method according to claim 1, wherein the at least one stack produced includes, at least one stack whose, axial edge defined by drape forming is curved, and whose machined axial edge is straight.

5. The manufacturing method according to claim 1, wherein a plurality of stacks are produced, said stacks comprising an inner stack and an outer stack radially superimposed on the inner stack the machined axial edge of the inner stack being obtained by a clean cut of the inner stack along a primary cutting surface and the machined axial edge of the outer stack being obtained by a clean cut of the outer stack along a secondary cutting surface different from the primary cutting surface.

6. The manufacturing method according to claim 5, wherein the axial edge defined by drape forming of the outer stack radially extends the machined axial edge of the inner stack, the secondary cut surface radially extending the axial edge defined by drape forming of the inner stack.

7. The manufacturing method according to claim 1, wherein the machined axial edge is obtained by clean cutting of the stack along a radial or frustoconical cutting surface.

8. A spacer ring obtained by a manufacturing method according to claim 1.

9. The manufacturing method according to claim 2, wherein preparing the upstream skin preform comprises, following said drape forming, shaping of the preform blank so as to form the upstream skin preform.

10. The manufacturing method according to claim 2, wherein preparing the downstream skin preform comprises, following said drape forming, shaping of the preform blank so as to form the downstream skin preform.

11. The manufacturing method according to claim 1, wherein the at least one stack produced includes at least one stack whose axial edge defined by drape forming is inclined, and whose machined axial edge is radial.

12. The manufacturing method according to claim 1, wherein a plurality of stacks are produced, said stacks comprising an internal stack and an external stack radially superimposed on the internal stack, the machined axial edge of the internal stack being obtained by a clean cut of the internal stack along a first cutting surface and the machined axial edge of the external stack being obtained by a clean cut of the external stack along a second cutting surface different from the first cutting surface, and wherein the axial edge defined by drape forming of the external stack radially extends the axial edge defined by drape forming of the internal stack, the second cutting surface radially extending the machined axial edge of the internal stack.

13. The manufacturing method according to claim 1, wherein the spacer ring is a rotating spacer ring.
